(19) United States
(12) Patent Application Publication
(10) Pub. No.: US 2026/0155657 A1
(43) Pub. Date: Jun. 4, 2026

(54) CONSTRUCTION ARRANGEMENT IN ELECTRIC POWER GENERATOR APPLIED TO SEMI-TRAILER WHEEL SET HAVING THE FUNCTION OF RECHARGING REFRIGERATION EQUIPMENT BATTERIES

(71) Applicant: FACCHINI S.A., São José do Rio Preto (BR)

(72) Inventor: Rubens Facchini, São José do Rio Preto (BR)

(21) Appl. No.: 19/406,139

(22) Filed: Dec. 2, 2025

(30) Foreign Application Priority Data
Dec. 2, 2024 (BR) 202024025205-0

(51) Int. Cl. H02J 7/14; B60P 3/20; B60R 16/033; H02K 7/116

(52) U.S. Cl. CPC H02J 7/1423; B60P 3/20; B60R 16/033; H02K 7/116

(57) ABSTRACT

A power generating mechanism installed on a wheelset equipped with a gearbox, the mechanism is designed to recharge batteries of refrigerated equipment, such as refrigerated wagons. The power generating mechanism has a transmission shaft having a grooved tip at one end and, at the opposite end thereof, a mechanical assembly with a drive pulley and a motor pulley interconnected by a toothed belt, which has a pair of tensioners. The motor pulley is connected to an electric power generating motor mounted on a structure external to the gearbox, which is split and composed of a housing and a cover for housing the drive pulley, the motor pulley and the tensioners. The model of the power generating mechanism aims to provide an efficient solution for generating electric power in semi-trailers.

### INTRODUCTION

This application refers to a utility model patent application that describes a CONSTRUCTION ARRANGEMENT IN ELECTRIC POWER GENERATOR APPLIED TO SEMI-TRAILER WHEELSET HAVING THE FUNCTION OF RECHARGING REFRIGERATION EQUIPMENT BATTERIES. The intended power generating equipment consists of a set of bearings, centering bushings, a drive pulley, and a belt integrated into a transmission shaft. This system is installed internally on one side of the semi-trailer wheelset, having the function of generating electric power exclusively for recharging the batteries dedicated to powering refrigeration equipment located in the refrigerated semi-trailer and for being activated in the refrigeration equipment when it is in operation, stopped, or in transit.

### FIELD OF APPLICATION

The electric power generator is applicable to semi-trailers equipped with electric or hybrid refrigerators, and is specifically designed to generate power to charge the batteries of refrigerating devices, when they are in operation, stopped or in transit.

### CURRENT STATE OF THE ART

The refrigerator type, refrigerated wagon semi-trailers have a refrigeration system consisting of an engine and a compressor, which are the main components responsible for cooling the wagon.

The operation of the refrigeration equipment is driven by the engine, which can currently be powered by three different sources: electric, diesel, or hybrid (diesel/electric) source.

The electrically powered refrigeration equipment is integrated into a semi-trailer wheelset, which is connected to an electric power generator. This generator uses a gear mechanism, which is more difficult to manufacture. Furthermore, the manufacture and assembly of this system entails higher financial costs.

For further information, check out some websites of manufacturers of geared generators designed for generating electric power in semi-trailer wheelsets:
https:/www.valx.eu/en/products/axles/e2-hd-energy-axles/
https://safholland.com/mide/en/products/saf-trakr

The patent application submitted herein shows significant functional differences compared to the state of the art by replacing the geared electric power mechanism with a belt mechanism. This new approach allows for variations, such as a toothed belt or chain drive.

### THE NEW MODEL

Upon identifying the differences present in the state of the art regarding an electric power generating equipment connected to a semi-trailer wheelset, which uses an oil-bathed gear mechanism, the inventor recognized the possibility of differentiation. In response to this need, an electric power generator based on a belt mechanism was developed. This new approach provides not only functional and operational improvements, but also results in a considerable reduction in manufacturing and assembly costs.

The new proposal relates to the protection of the construction arrangement of an electric generator operating through a belt mechanism. This generator consists of a transmission shaft, the end of which is equipped with a centering bushing that accommodates a retainer. The end of the transmission shaft is grooved, allowing coupling to the hubcap of the wheelset. At the opposite end, there is another centering bushing, which connects to an elastic coupling. Then, following the elastic coupling, there is a drive pulley, which contains a pair of bearings. The drive pulley is connected by a belt to a motor pulley, which is also equipped with a pair of bearings. Finally, the motor pulley has, at one end thereof, a coupling shaft that connects to an electric motor responsible for supplying the refrigeration equipment battery pack. The toothed belt has a pair of belt tensioners, which are located above and below the motor pulley.

The bushing function is to center and support the ends of the electric generator transmission shaft within the wheelset. The centering bushing helps ensure proper shaft alignment, allowing for more efficient operation of the mechanism. Additionally, it can act as a support point for other components, such as the retainer and the elastic coupling, contributing to system stability and durability.

The retainer function is to prevent grease of bearings or other contaminants from entering the generator. The retainer acts as a barrier that protects the internal parts of the mechanism, ensuring efficient system operation and extending component lifespan. The retainer, along with the centering bushing, ensures proper operation of the transmission shaft, thus minimizing wear and maintenance need.

In addition to the generator belt mechanism, there is an additional element that offers technical and operational advantages that traditional gear mechanisms cannot provide. These advantages include vibration absorption, which reduces shocks during operation and protects other system components.

The elastic coupling also allows for misalignment compensation, adapting to small variations between the connected shafts, which prevents premature wear and failure. Another benefit is noise reduction, as it absorbs vibrations and contributes to quieter operation. Furthermore, the coupling acts as a component protector, preventing excessive forces from being transmitted, which can cause damage. Finally, by absorbing shocks and vibrations, the elastic coupling increases system durability as a whole.

The entire mechanism described herein, when in motion, allows the battery pack that powers refrigeration equipment to be recharged, and this power can then be used when the pack is stationary. This approach does not only optimize power use, but also contribute to sustainability by reducing the need for external power sources and improving the efficiency of refrigeration systems.

### TECHNICAL ADVANTAGES

The advantages of an electric generator that uses a drive pulley mechanism with a belt, a toothed belt, or a chain compared to oil-bathed gears include:
Lower Maintenance: Belt systems tend to require less maintenance than oil-bathed gears, which may require oil changes and constant monitoring of the lubricant level.
Power Efficiency: Belt mechanism can offer more efficient power transmission, reducing the power losses that can occur in gear systems due to friction and oil resistance.
Cost: Manufacturing and installing a belt can be more economical compared to complex gears that require additional components for lubrication.
Lower Noise: In many cases, belt systems operate more quietly than gears, which can be an advantage in applications where noise level is a concern.

### ILLUSTRATIONS OF THE NEW MODEL

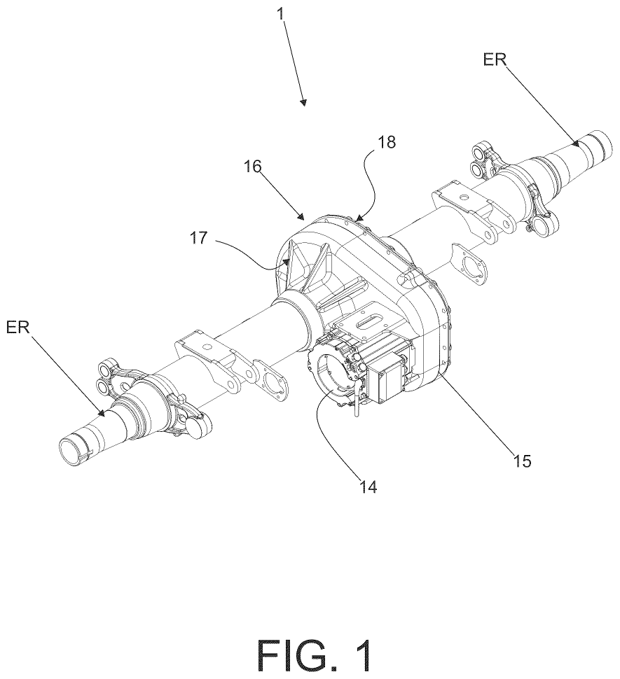

For a better understanding of the construction arrangement in electric power generator applied to semi-trailer wheelset having the function of recharging refrigeration equipment batteries, such as refrigerated wagons, the following related illustrations are presented:
FIG. 1: Perspective view of the power generator assembly inserted into the wheelset.

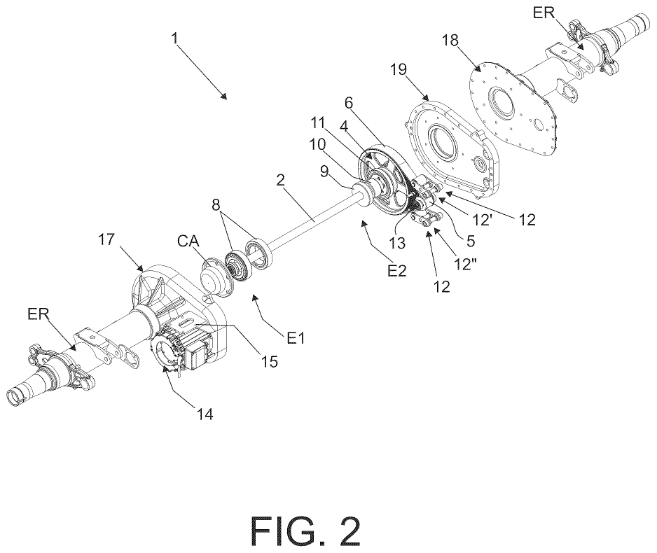

FIG. 2: Exploded perspective view of the power generator assembly.

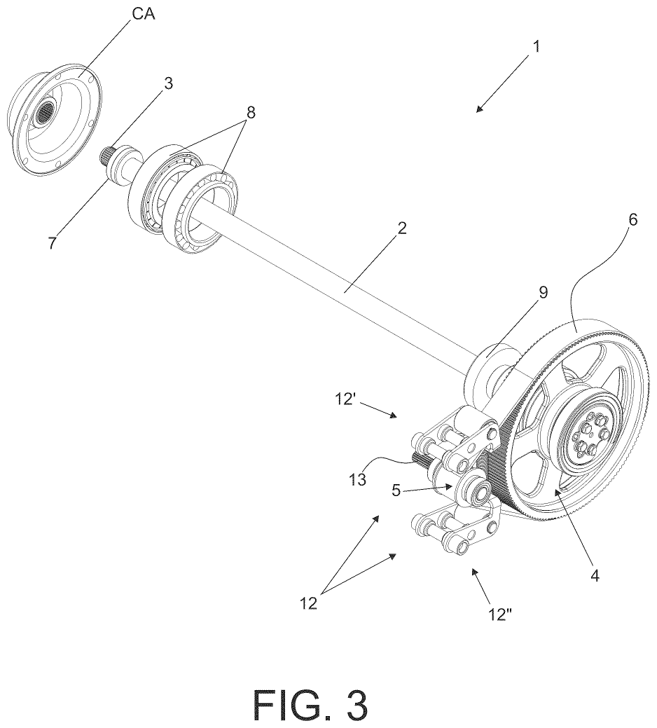

FIG. 3: Perspective view of the internal power generator assembly.

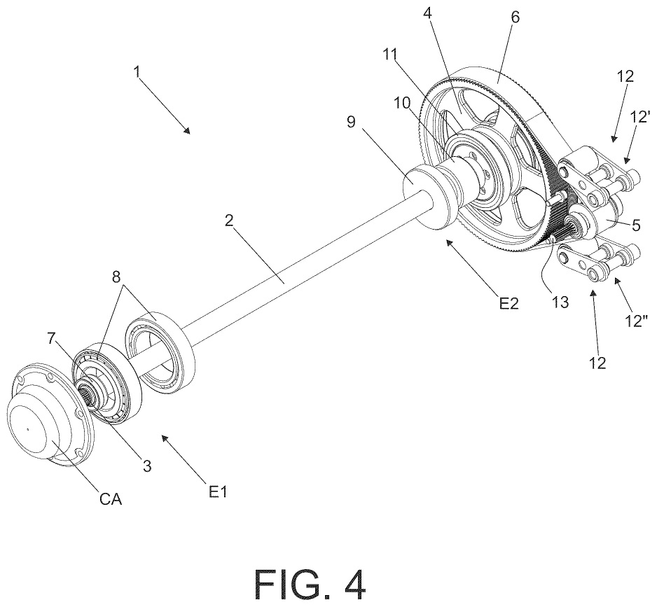

FIG. 4: Inverted perspective view of the internal power generator assembly.

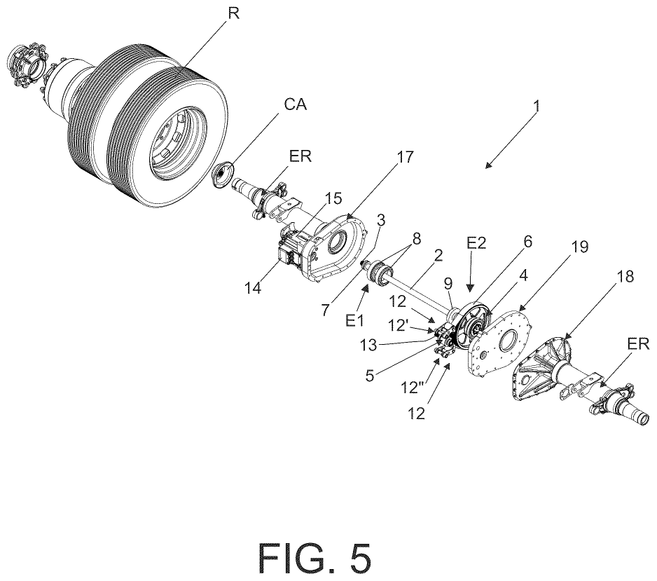

FIG. 5: Exploded perspective view of the power generator assembly in relation to a wheelset.

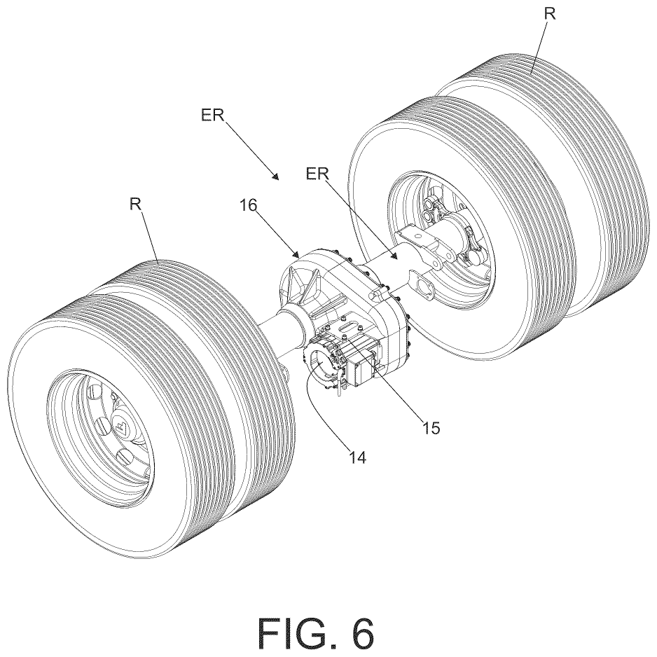

FIG. 6: Perspective view of the power generator assembly mounted to a wheelset.

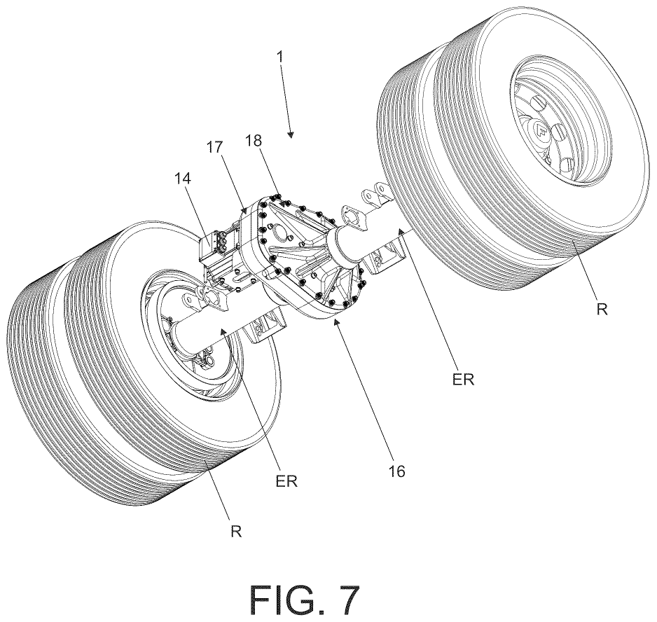

FIG. 7: Perspective view of the power generator assembly mounted to a wheelset, in an inverted view compared to the previous figure.

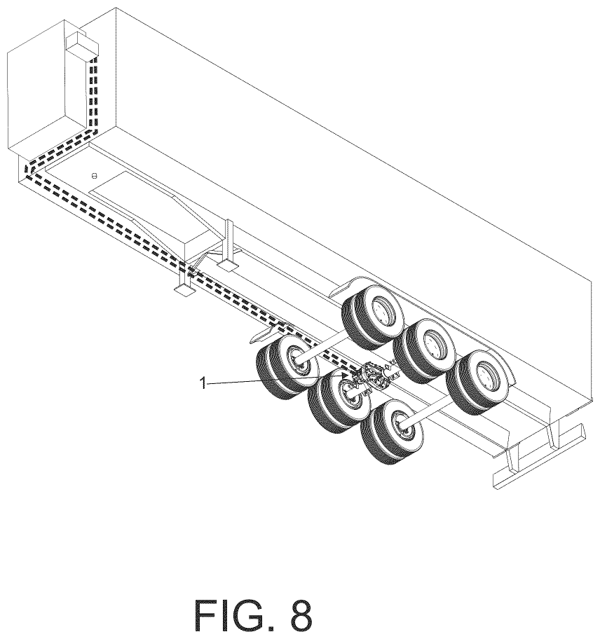

FIG. 8: Perspective view of the power generator assembly mounted to a refrigerated vehicle, as an example of the application.

### TECHNICAL DESCRIPTION

The CONSTRUCTION ARRANGEMENT IN ELECTRIC POWER GENERATOR APPLIED TO SEMI-TRAILER WHEELSET HAVING THE FUNCTION OF RECHARGING REFRIGERATION EQUIPMENT BATTERIES, which is the object of this utility model patent application, comprises a power generating mechanism (1), which is composed of a transmission shaft (2). At one end (E1), the shaft has a grooved tip (3), while at the opposite end (E2) it is equipped with a mechanical assembly that includes a drive pulley (4) interconnected to a motor pulley (5) by a toothed belt (6).

The grooved tip (3) is connected to the hubcap (CA), which is attached to the wheel well (R). This configuration allows for efficient rotation of the transmission shaft (2), contributing to the operation of the electric power generating mechanism (1).

The transmission shaft (2) is equipped, at both ends (E1) and (E2), with elements that ensure the alignment, centering, and vibration absorption of the transmission shaft (2) inserted internally into the wheelset structure (ER).

At the end (E1), away from the grooved tip (3), the transmission shaft (2) is equipped with a retainer (7) juxtaposed with a centering bushing (8). At the opposite end (E2), there is a centering bushing (9) providing greater stability and alignment. Between the drive pulley (4) and the centering bushing (9), there is an elastic coupling (10) that integrates a pair of bearings (11). Each bearing (11) is positioned so as to be in contact with the sides of the drive pulley (4), allowing efficient torque transmission and minimizing mechanical wear, in addition to ensuring smooth and quiet operation of the system.

The drive pulley (4) and the motor pulley (5) are arranged in a parallel configuration and interconnected by a toothed belt (6). The tensioning system consists of a pair of tensioners (12), wherein one tensioner (12′) is positioned above the motor pulley (5), while the other tensioner (12″) is located below the same motor pulley (5). This configuration ensures that the toothed belt (6) tension is maintained efficiently, optimizing power transmission and system durability.

The motor pulley (5) is equipped with a coupling shaft (13), which connects to an electric power generating motor (14) mounted on a structure (15) external to the wheelset (ER).

The wheelset (ER), while presenting a configuration already known in the state of the art, undergone a construction arrangement improvement of the gearbox (16), which is centered in relation to said wheelset (ER). Although it is not an improvement project, this centralization is essential for the system efficiency, ensuring a balanced distribution of forces and smooth operation.

The gearbox (16) is designed in a split form, consisting of a housing (17) and a cover (18). A spacer plate (19) is inserted between the housing (17) and the cover (18) to optimize alignment and fastening of the internal components, which are the drive pulley (4), the motor pulley (5), the toothed belt (6), and the tensioners (12). This construction arrangement does not only facilitate assembly and maintenance of the gearbox (16), but also contribute to system robustness and durability as a whole, ensuring reliable performance under varied operating conditions.

The power generating mechanism (1) presented herein demonstrates an exceptional construction arrangement, reflecting an innovative and efficient design. The transmission shaft (2), with its ends (E1) and (2) equipped to ensure alignment and vibration absorption, provides smooth operation and minimizes mechanical wear. The selection of centering bushings (8) and (9) with different diameters offer greater stability, while the elastic coupling (10) integrated with the bearings (11) ensures efficient torque transmission.

The parallel construction arrangement of the pulleys-the drive pulley (4) and the motor pulley (5) interconnected by a toothed belt (6) and supported by a pair of tensioners (12) strategically positioned-optimizes system tension and durability. This construction approach ensures reliable and efficient performance, even under challenging operating conditions, standing out as an innovative solution in the field of power generation.

1. (canceled)

2. A construction arrangement in electric power generator applied to a semi-trailer wheelset having a function of recharging refrigeration equipment batteries, comprising:
a power generating mechanism installed on a wheelset equipped with a gearbox, wherein the power generating mechanism includes:
a transmission shaft having, at one end, a grooved tip that is connected to a hubcap, which is fixed to a wheel well, and having, at the opposite end thereof, a mechanical assembly that includes a drive pulley interconnected to a motor pulley by means of a toothed belt, and the transmission shaft is equipped, at the end, with a retainer and a centralizing bushing and, at the opposite end thereof, with a centralizing bushing, the opposite end being equipped with an elastic coupling between the drive pulley and the centralizing bushing, and a pair of bearings positioned in contact with the sides of the drive pulley; the drive pulley and the motor pulley are arranged in parallel, interconnected by a toothed belt that comprises a pair of tensioners, wherein one tensioner is positioned above the motor pulley, while another tensioner is located below the same motor pulley; the motor pulley is connected to an electric power generating motor mounted on a structure external to the gearbox of the wheelset; the gearbox is designed in a split form, including a housing and a cover for housing the drive pulley, the motor pulley, and the pair of tensioners; and a spacer plate inserted between the housing and the cover.
